(19) United States
(12) Patent Application Publication
(10) Pub. No.: US 2012/0193913 A1
(43) Pub. Date: Aug. 2, 2012

(54) control device for an electric machine and method for the operation thereof

(76) Inventors: Hubert Schweiggart, Stuttgart (DE); Wolfgang Mueller, Stuttgart (DE); Guenter Reitemann, Schwieberdingen (DE); Michael Merkle, Stuttgart (DE); Marcus Abele, Schwieberdingen (DE); Christian Prag, Stuttgart (DE)

(21) Appl. No.: 13/383,643

(22) PCT Filed: Jul. 14, 2010
(86) PCT No.: PCT/EP2010/060153

§ 371 Date: Apr. 13, 2012

(30) Foreign Application Priority Data
Jul. 22, 2009 (DE) 102009027931.8

(51) Int. Cl. H02K 23/52

(52) U.S. Cl. 290/31

(57) ABSTRACT

An electronic control device for a starter-generator or a starter for an internal combustion engine in a motor vehicle has a control and a circuit configuration that includes a pulse-controlled inverter. The control device includes the pulse-controlled inverter, the corresponding control, and a DC/DC converter in one structural unit.

### BACKGROUND OF THE INVENTION

1. Field of the Invention

The present invention relates to a control method and an electronic control device for an electric machine, e.g., a starter-generator or a starter for an internal combustion engine in a motor vehicle, having a control and a circuit configuration that includes a pulse-controlled inverter.

2. Description of Related Art

Starting an internal combustion engine in a motor vehicle requires high power levels, in particular high currents of potentially 1000 amperes or more for a starter motor. In conventional vehicle electrical system topologies, these currents are supplied from a battery. High peak currents induce a high pulse-shaped starting torque of the starter motor, thus also a high mechanical load and a dip in the voltage in the vehicle electrical system.

It is generally known to use a starter-generator for the internal combustion engine and, in fact, inter alia also for a hot start in a start-stop system, such starter-generators being rated for a 14 V vehicle electrical system. A starter-generator is used both as a starter motor and as an electric generator in the motor vehicle. Under certain circumstances, an additional conventional starter is provided for a cold start. In the case of an internal combustion engine-driven, generative operation of the starter-generator, the starter-generator supplies the vehicle electrical system with electric power, and the battery is also charged, in particular.

The operation of the starter-generator in the motor vehicle requires electronics, such as a pulse-controlled inverter having power switches, mostly semiconductor components, the pulse-controlled inverter, in particular the power switches, being driven by a control.

The published German Patent Application DE 103 30 703 A1 describes a generator, which, in addition to an electric machine, also includes a regulator and a pulse-controlled inverter to whose output a DC/DC converter is also connected in order to generate a desired nominal voltage, for example 14 V, for the operation of consumers on the vehicle electrical system. A control unit for driving the pulse-controlled inverter is also connected to the vehicle electrical system.

It is an object of the present invention to further refine an electronic control device and an operating method of the type mentioned at the outset in order to reduce the expenditure required for material, components and assembly.

### BRIEF SUMMARY OF THE INVENTION

Underlying the present invention is the fundamental idea that the control device include a pulse-controlled inverter, a corresponding control, and a DC/DC converter in one structural unit. Thus, different functional groups may be combined in one advantageous circuit topology to form one structural unit. The objective is also achieved by a method for operating a control device, preferably the aforementioned control device, where both the pulse-controlled inverter, as well as the DC/DC converter are driven by the control, so that only one single control is needed for driving at least two functional groups, namely the pulse-controlled inverter and the DC/DC converter functional groups. The control device, as well as the method for the operation thereof make it possible to reduce the outlay required for material, components and/or assembly, and to reduce the weight of the control device.

In particular, the structural unit of the pulse-controlled inverter makes it possible for the corresponding control and the DC/DC converter to be configured as one module, in particular in a shared housing. This reduces the material and manufacturing outlay and permits simple assembly of the control device.

It is preferred that the pulse-controlled inverter and the DC/DC converter be realized by one shared circuit configuration, in one specific embodiment for example, by interconnected printed circuit boards having electronic components, or preferably by one printed circuit board that at least partially includes the pulse-controlled inverter and the DC/DC converter in each case. The material and manufacturing outlay, and the weight of the control device are thereby reduced.

The electronic control device is used, in particular, for operating a starter, a generator and/or, in an especially preferred manner, a starter-generator for an internal combustion engine in a motor vehicle. It is particularly advantageous for motor vehicles that a control device have a compact design encompassing different functional groups in one structural unit, making it possible to economize weight by reducing the outlay for material and components, or also to minimize assembly outlay in the case of assembly or maintenance work for the motor vehicle. Space requirements are also thereby reduced.

The following describes various conversion types and conversion directions of the DC/DC converter. They are each preferred as a specific embodiment, alone or in any given combinations, further advantages being discussed further below, particularly in conjunction with an energy storage device.

The DC/DC converter is able to convert a DC voltage of a motor vehicle electrical system to another DC voltage. Thus, the pulse-controlled inverter may be operated at a voltage above a vehicle system voltage, for example, to enhance a power efficiency or, at the same, to also supply electric power to the vehicle electrical system via the DC/DC converter and, in fact, at a reduced vehicle system voltage relative to the pulse-controlled inverter, for instance at 14 V.

The DC/DC converter makes it possible to convert a DC voltage of a motor vehicle electrical system to another DC voltage in order to produce a voltage from the vehicle system voltage that differs therefrom that may also be used for supplying power to other components of the control device, in particular of the circuit configuration, or also of the motor vehicle, thus outside of the control device. Thus, an additional functionality is integrated in the electronic control device, and the outlay for material, components or assembly is thereby reduced.

Moreover, the DC/DC converter may be used to convert a DC voltage to a DC voltage of the electrical system. Thus, the vehicle electrical system may be fed from a DC voltage source that supplies a voltage that differs from the vehicle system voltage, thereby integrating a further functionality in the structural unit of the electronic control device.

A DC voltage is preferably stepped down by the DC/DC converter. Thus, to achieve a greater power efficiency, the starter-generator may be operated at an increased voltage relative to the vehicle system voltage, for example, and the DC voltage obtained from the starter-generator may be stepped down to a suitable vehicle system voltage.

It is also preferred that a DC voltage be stepped up by the DC/DC converter. In this context, it is equally possible for a voltage that is below the vehicle system voltage to be stepped up to the vehicle system voltage, for instance, to supply the vehicle electrical system with electric power, and for the vehicle system voltage to be stepped up to another, higher DC voltage, for example, to operate a high-voltage consumer, to increase a power efficiency, or to reduce line losses.

In accordance with one preferred specific embodiment, the circuit configuration includes at least one electronic device, in particular the control, which functions both with the pulse-controlled inverter, as well as with the DC/DC converter. Thus, a multiple use of the device is made possible, thereby reducing the outlay required for material, components and/or assembly, and thus also reducing the weight.

It is also preferred that a power switch, in particular a transistor, for example a MOSFET, be both an integral part of the pulse-controlled inverter, as well as of the DC/DC converter. By reducing the number of required power switches, it is possible to reduce the costs for manufacturing the control device or also the assembly outlay entailed since power switches require special measures for dissipating heat.

The circuit configuration preferably includes a switching device, in particular an electronic switch, for example a MOSFET, for an electronic energy storage device. Thus, the power storage may be connected to or also disconnected from the control device, as needed, for example to draw energy from the energy storage device or to charge the same. Moreover, the switching device is able to prevent a battery of the vehicle electrical system from discharging, particularly in the case of a motor vehicle standstill, due to leakage currents of the energy storage device. In addition, a defective energy storage device may be isolated. Thus, the control device assumes an additional functionality, namely the energy flow from or to the energy storage device.

The energy storage device preferably includes a double-layer capacitor. Double-layer capacitors are suited for rapidly taking up or also releasing energy, so that they may also be advantageously used for start-stop systems in a motor vehicle, for example, in that the vehicle electrical system or the electric machine, in particular the starter-generator or the starter, is supplied with electric power upon starting of the internal combustion engine.

Through suitable control by the control device, the energy storage device and/or the vehicle system battery may be used to increase the performance of the internal combustion engine, which is generally referred to as active boosting, additional kinetic energy being supplied to the motor vehicle by the electric machine which assists the drive power of the internal combustion engine, for example, in that the starter-generator or starter coupled to the internal combustion engine is driven as a motor by electric power from the energy storage device, respectively from the battery.

In addition, what is generally referred to as a passive boosting may also be implemented by the control device, in that, during operation of the internal combustion engine, an internal combustion engine-driven electric machine, in particular the starter generator, is deactivated as a generator, thus no electric power is drawn therefrom. Thus, the portion of the kinetic energy generated by the internal combustion engine that is available for driving the motor vehicle, is increased. During this phase, the vehicle electrical system including the power consumers is preferably powered from the energy storage device and/or the conventional battery.

In accordance with one preferred specific embodiment, the circuit configuration of the control device in the structural unit also includes the energy storage device, in particular at least one double-layer capacitor. Thus, a power storage functionality may be integrated in the control device compactly and/or in a weight-saving manner and, in particular, the assembly outlay may also be reduced.

In the case of a recuperation, energy is preferably stored in the energy storage device and/or in the battery. Thus, for example, in the case of a braking of a motor vehicle, kinetic energy is converted by the electric machine, in particular the starter-generator, into electric power and stored in the energy storage device, preferably the double-layer capacitor. The stored energy may then be fed to the vehicle electrical system for power consumers, or also supplied to the electric machine, in particular to a starter or a starter-generator, for example, for starting the internal combustion engine in the case of a start-stop system or also for power assistance for the internal combustion engine in the case of an acceleration of the motor vehicle.

In the case of a recuperation, it is preferred that an output voltage at the pulse-controlled inverter be stepped up in order to charge the energy storage device, in particular the double-layer capacitor, as effectively as possible. Moreover, it is also preferred that the vehicle electrical system be supplied with power via the DC/DC converter, in particular in that the stepped-up output voltage at the pulse-controlled inverter be stepped down to a lower vehicle system voltage, for example to 14 V or 28 V. Thus, upon charging of the energy storage device, the power efficiency may be enhanced by increasing the voltage relative to the vehicle electrical system, and power consumers may continue to be fed current at the level of the vehicle system voltage.

In addition, it is preferred that a DC voltage of the energy storage device be stepped up to the DC voltage of the vehicle electrical system in order to discharge the energy storage device to below vehicle system voltage, in particular to store more energy in the energy storage device during the recuperation.

In accordance with one especially preferred specific embodiment, the electric machine, the energy storage device and/or also the pulse-controlled inverter are operated at an increased voltage relative to the vehicle system voltage, and, in fact, preferably at approximately double, triple or also quadruple the vehicle system voltage, in that the DC voltage of the, in particular battery-fed, vehicle electrical system, is converted by the DC/DC converter to the increased voltage, thus is stepped up. Thus, the power efficiency of the electric machine and/or also of the energy storage device are/is enhanced, and, for example, a start may be facilitated by operating the starter-generator or the starter using the increased voltage.

For a voltage conversion, the control device may include a plurality of parallel-connected DC/DC converters, which may also be each characterized as a phase in order to reduce a current load of an individual DC/DC converter, in the case of a total current to be converted. Thus, DC/DC converters having smaller power switches and lower inductances may be used, because an increasing current load requires a disproportionate dimensioning of the components since the current load increases or decreases by square in response to a change in the current. This makes it possible to reduce the manufacturing costs and the weight of the control device.

In another preferred specific embodiment, the circuit configuration includes a bypass switching device for bypassing the DC/DC converter. The bypass switching device may be a semiconductor switch or a relay, and it is preferably closed when the pulse-controlled inverter is at the level of the vehicle system voltage, so that the bypassing reduces the electrical losses through the DC/DC converter, since there is no need in this case for any voltage conversion by the DC/DC converter.

It is preferred that the pulse-controlled inverter be used, in particular, to limit an operating current, in particular an AC current, of the electric machine, in particular in an operation as starter motor of the internal combustion engine, and, in fact, for example, in the case of a cold start of the internal combustion engine, or also in the case of a hot start, particularly in the case of a start-stop system. In this context, the electric machine is used as a motor for driving the internal combustion engine during a start. Limiting the current reduces the danger of a voltage dip in the vehicle electrical system and minimizes disturbances in the supplying of electric power to power consumers.

In addition, it is preferred that, in the case that a starter, in particular a conventional starter is needed in addition to a starter-generator for the cold start of the internal combustion engine, the starter be driven in a clocked mode via the pulse-controller inverter, in particular by a DC current, in order to limit the starting current of the additional starter. It is necessary to ensure that the starter-generator not supply any electrical energy to the pulse-controlled inverter upon starting of the motor, particularly when the additional starter is used, and, in fact, by setting an excitation current of the starter-generator to zero, for example. Thus, the outlay for components is reduced in that the control device drives both the starter-generator, as well as the additional starter, in a clocked mode in particular. In the case of a start-stop system, a hot start is preferably carried out by the starter-generator via the pulse-controlled inverter, thus without any additional starter.

In one preferred specific embodiment, another mechanical component of the motor vehicle other than the internal combustion engine, is driven by the electric machine. Thus, particularly in the case of a start-stop system, at least one aggregate of the motor vehicle, for example a compressor of an air-conditioning system, may be mechanically driven in the case that the internal combustion engine is stopped.

### BRIEF DESCRIPTION OF THE DRAWINGS

FIG. 1 shows a schematic circuit diagram of a power supply system in a motor vehicle.

FIG. 2 shows a schematic circuit diagram of a control device having a DC/DC converter.

FIG. 3 shows a schematic circuit diagram of another control device having a DC/DC converter.

FIG. 4 shows a schematic circuit diagram of another control device having another DC/DC converter.

FIG. 5 shows a schematic circuit diagram of another control device having a DC/DC converter.

FIG. 6 shows a schematic circuit diagram of another control device having a DC/DC converter.

FIG. 7 shows a schematic circuit diagram of another control device having a DC/DC converter.

### DETAILED DESCRIPTION OF THE INVENTION

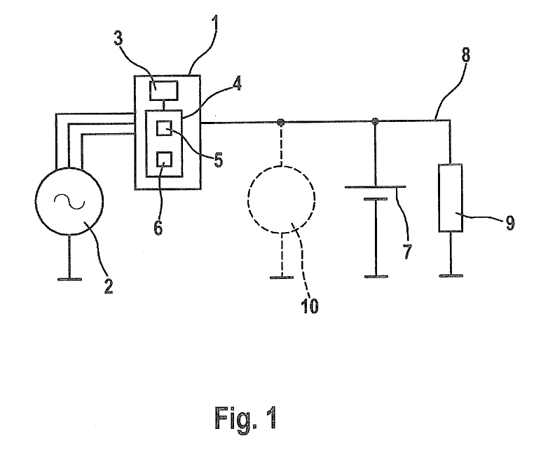

FIG. 1 shows a schematic circuit diagram of an electric power supply system in a motor vehicle that encompasses an electronic control device 1 according to the present invention and a starter-generator 2 as an electric machine, as well as a vehicle electrical system 8 having a vehicle system voltage of approximately 14 V. Connected to vehicle electrical system 8 are power consumers 9, a battery 7 and, optionally, a conventional starter 10.

Electronic control device 1 includes a control 3 and, in a circuit configuration 4, a pulse-controlled inverter 5 and a DC/DC converter 6 which are configured as a structural unit in one shared housing. Control 3 drives both pulse-controlled inverter 5, as well as DC/DC converter 6, pulse-controlled inverter 5 and DC/DC converter 6 being essentially realized from electronic components that are configured on one printed circuit board. Functionally, therefore, control device 1 is used as an independent module.

The motor vehicle has a start-stop system having an internal combustion engine (not shown), in the case of a hot start, the internal combustion engine being started by starter-generator 2 that is being operated, in that starter-generator 2 is driven as an electric motor by an AC current by the pulse-controlled inverter. To the extent that it is present, starter 10 operated by DC current is used for a cold start of the internal combustion engine. Alternatively, it is also possible that the motor vehicle design does not include optional starter 10; the internal combustion engine then being started by starter-generator 2 in the case of a cold start.

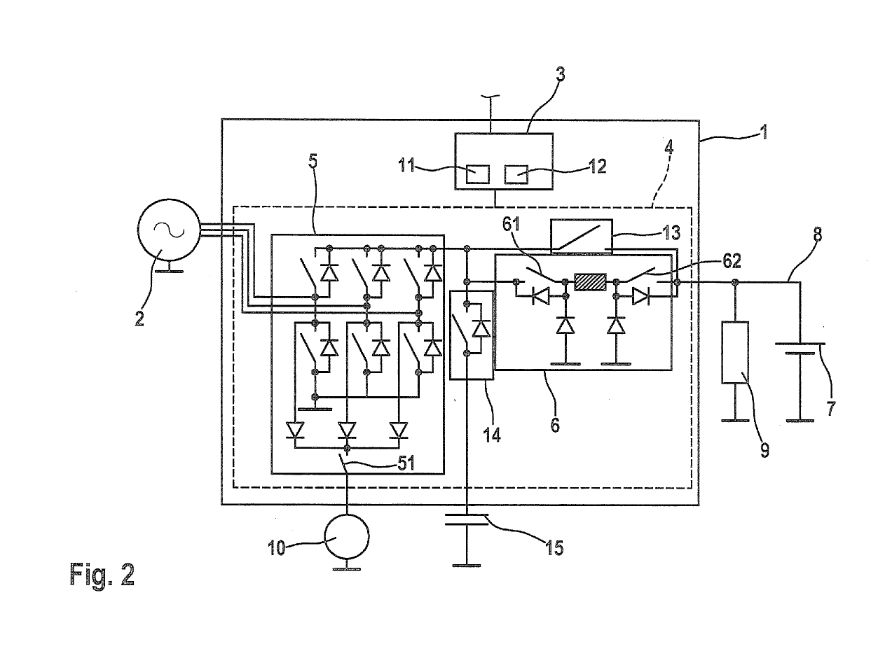

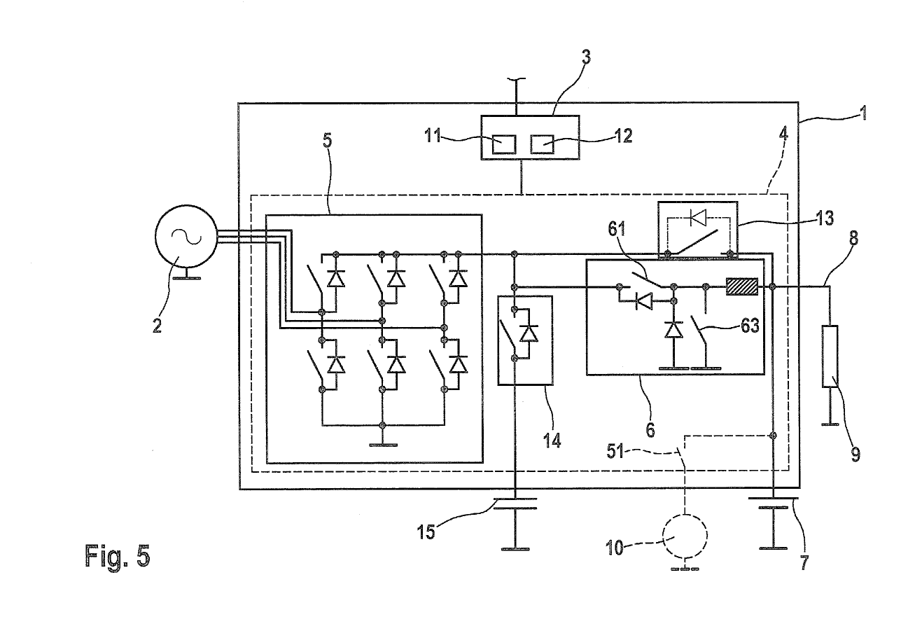

FIG. 2 through FIG. 7 each show a schematic representation of a control device 1 according to the present invention that is electrically connected to starter-generator 2, battery 7, an energy storage device 15 and vehicle electrical system 8 including power consumers 9 and, in some instances, to conventional starter 10 that is switchable by a switch 51. Starter 10 in each of FIG. 2 through FIG. 4 is driven in a clocked mode via pulse-controlled inverter 5, while starter 10 of FIG. 5 through FIG. 7 is directly energized by battery 7 via switch 51.

In control devices 1 described in the following, at least one pulse-controlled inverter 5, a DC/DC converter 6, a bypass switching device 13, and a switching device 14 for energy storage device 15 are combined in one structural unit to form a circuit configuration 4.

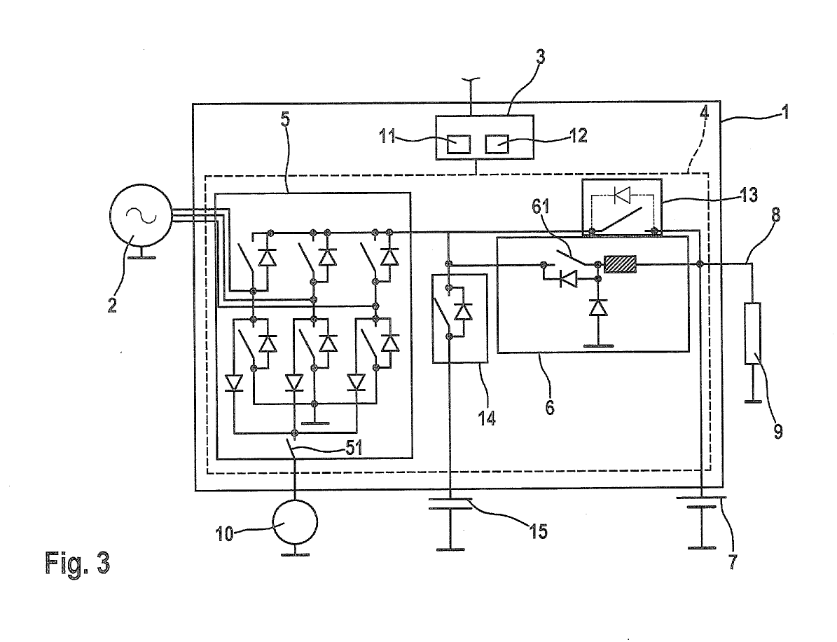

In all of the exemplary embodiments, energy storage device 15 is configured as a double-layer capacitor, and, in addition, battery 7 is connected via vehicle electrical system 8 to power consumers 9, the exemplary embodiments in accordance with FIG. 3 through 7 each featuring separate connections of control device 1 for battery 7 and vehicle electrical system 8 in order to realize cables between battery 7 and control device 1 whose conductor cross sections are enlarged relative to the vehicle electrical system to permit high starter currents of up to 1000 A.

In addition, each of illustrated control devices 1 has a control 3 having a microcomputer 11 and a memory 12 in which a computer program product to be executed in microcomputer 11 is loaded in order to drive at least pulse-controlled inverter 5, DC/DC converter 6, switching device 14, and bypass switching device 13 (not shown for the sake of better legibility).

Switching device 14 for energy storage device 15 is configured in each case as a semiconductor switch and, in fact, designed to include a MOSFET, via which energy storage device 15 is charged, respectively discharged in a controlled operation, also in a feedback operation, in particular by an operation of the MOSFET in a linear range. In terms of function, switching device 14 operates both with pulse-controlled inverter 5, as well as with DC/DC converter 6, to supply energy from energy storage device 15 to both together or also to only one of the two at a time, or also to conduct energy from these into energy storage device 15. Moreover, a discharging of battery 7 in the case of motor vehicle standstill due to leakage currents of energy storage device 15 may be prevented, or a defective energy storage device 15 may be electrically isolated.

Moreover, control device 1 makes it possible for starter-generator 2 to drive other mechanical components, such as an air conditioning system, for example, during a standstill of the internal combustion engine, particularly in the case of a start-stop operation, in that starter-generator 2 is supplied from energy storage device 15 and/or from battery 7.

In a schematic circuit diagram, FIG. 2 shows an exemplary embodiment of an electronic control device 1 according to the present invention. Pulse-controlled inverter 5 is designed for the operation of starter-generator 2 and for a clocked actuation as a current limitation of starter 10.

Besides pulse-controlled inverter 5, circuit configuration 4 also encompasses switching device 14 described above, DC/DC converter 6 and bypass switching device 13, in one structural unit. DC/DC converter 6 links vehicle electrical system 8 to pulse-controlled inverter 5 and to switching device 14 for energy storage device 15, DC/DC converter 6 being able to be bypassed by a relay constituted as bypass switching device 13, so that, in the case of an equal potential condition on both sides of DC/DC converter 6, thus when the vehicle system voltage and the voltage at pulse-controlled inverter 5 are equal, losses through DC/DC converter 6 may be minimized by bypassing the converter.

To be able to perform a voltage reduction function, DC/DC converter 6 features an electronic switch 61, namely a MOSFET having a diode, that allows a DC voltage from pulse-controlled inverter 5 and/or energy storage device 15 to be stepped down to the DC voltage of vehicle electrical system 8 when vehicle electrical system 8 is being fed by energy storage device 15 or by starter-generator 2 via pulse-controlled inverter 5. Starter-generator 2 may then be operated at an increased voltage level relative to the vehicle electrical system, for example in order to enhance the power efficiency.

Moreover, using another electronic switch 62, DC/DC converter 6 may step down DC voltage of vehicle electrical system 8 to a DC voltage at pulse-controlled inverter 5 and, therefore, also at energy storage device 15 to enable battery 7 to charge energy storage device 15 to the level of the vehicle system voltage. By applying this second voltage reduction function, energy storage device 15 may facilitate a start of the internal combustion engine, or a voltage dip in vehicle electrical system 8 may also be reduced. Thus, DC/DC converter 6 of FIG. 2 has a bidirectional design and features two voltage reduction functions.

In addition, control device 1 renders possible active and passive boosting in that electrical energy from energy storage device 15 is supplied as additional kinetic energy to the motor vehicle via starter-generator 2, respectively in that starter-generator 2 is deactivated during a generator operation of the internal combustion engine, and vehicle electrical system 8 is powered by energy storage device 15.

In a schematic circuit diagram, FIG. 3 shows another exemplary embodiment of a control device 1 that differs from that shown in FIG. 2, particularly with regard to DC/DC converter 6 and bypass switching device 13.

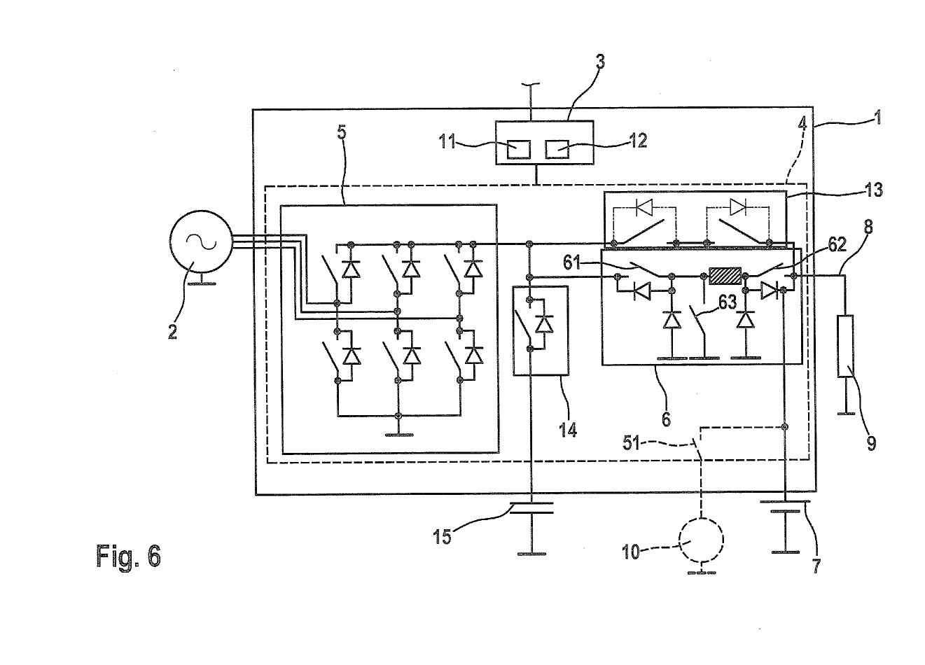

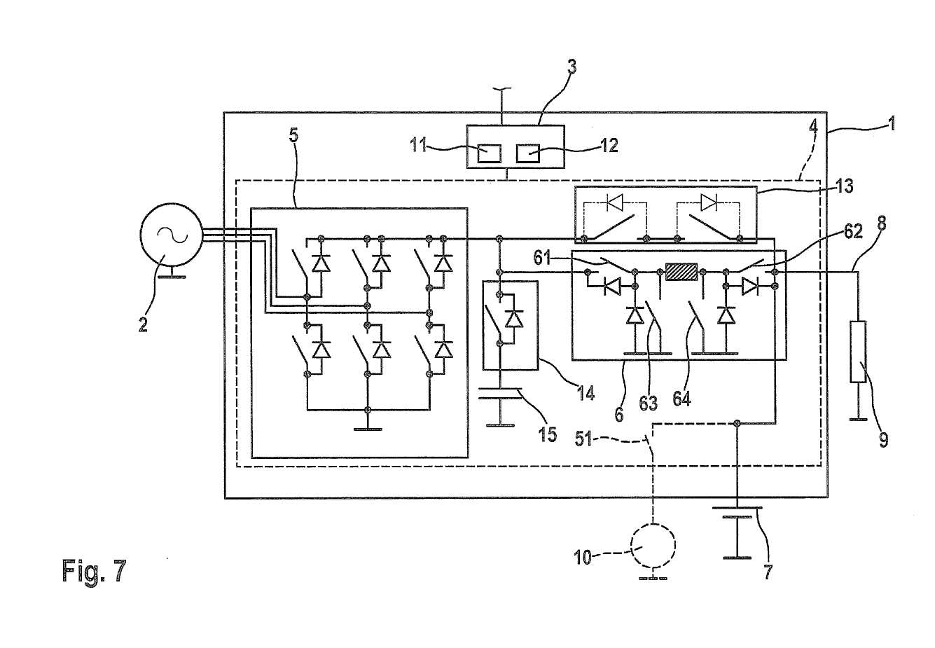

In this, as well as in each the following exemplary embodiments, bypass switching device 13 is designed as one, respectively, in FIGS. 6 and 7, as two semiconductor switches, each having a MOSFET.

In this exemplary embodiment, DC/DC converter 6 is configured to have only one electronic switch 61, thus, in particular, to be unidirectional and, in fact, in order to step down a DC voltage of pulse-controlled inverter 5 and/or of energy storage device 15 to the vehicle system voltage.

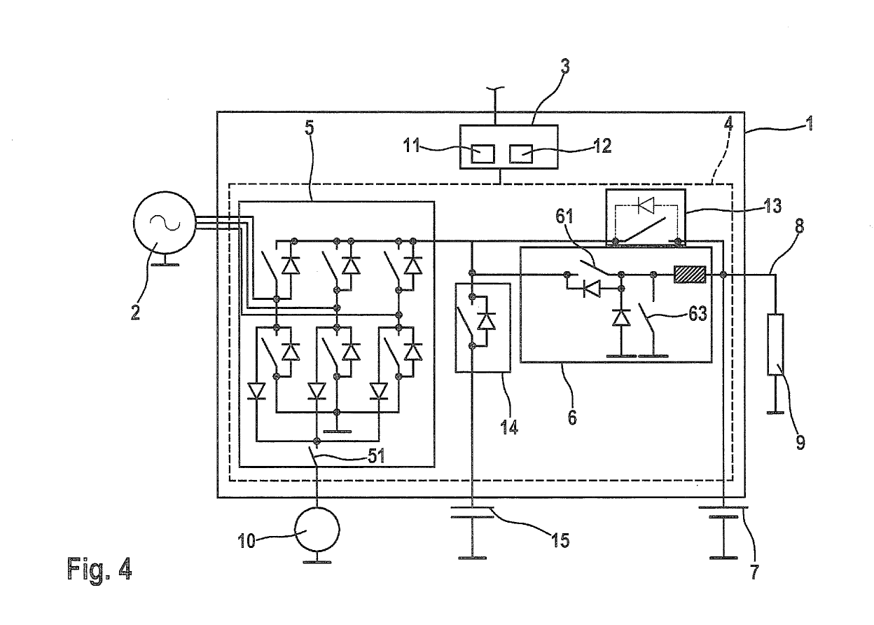

In a schematic circuit diagram, FIG. 4 shows another exemplary embodiment of a starting device 1, which differs from that shown in FIG. 3 by an electronic switch 63 in DC/DC converter 6 that is thereby designed for a bidirectional operation and, in fact, features a voltage reduction function in order to step down a voltage of pulse-controlled inverter 5 and/or of energy storage device 15 to the vehicle system voltage via switch 61, as previously explained; and, in addition, features a voltage boost function, in order to step up the DC voltage of vehicle electrical system 8 to a DC voltage of pulse-controlled inverter 5, thus also of energy storage device 15, via switch 63, and to boost the voltage of the energy storage device to a higher level than that of the vehicle electrical system. Thus, in the case of a start of the internal combustion engine, starter-generator 2 may be operated at a higher voltage, and the next start be thereby facilitated.

In a schematic circuit diagram, FIG. 5 shows another exemplary embodiment of a control device 1, which differs from that shown in FIG. 4 by circuit configuration 4 with respect to the actuation of starter 10. In this exemplary embodiment, starter 10 is, in fact, controlled by control device 1, however is directly energized by battery 7. Thus, in the case of a start of the internal combustion engine, pulse-controlled inverter 5 and, in particular, also starter-generator 2 may remain switched off, for example in order to decrease a current consumption by control device 1 and to reduce a voltage dip in vehicle electrical system 8.

The circuit diagram schematically illustrated in FIG. 6 differs from that shown in FIG. 5 by bypass switching device 13 and DC/DC converter 6. In this exemplary embodiment, DC/DC converter 6 is configured to include switches 61, 62, 63; namely it features two voltage reduction functions for a bidirectional operation, and one voltage boost function and, in fact, in order to step down a DC voltage from pulse-controlled inverter 5, thus also from energy storage device 15, to a DC voltage of vehicle electrical system 8; in order to step up a DC voltage of vehicle electrical system 8 to a DC voltage of pulse-controlled inverter 5, thus also of energy storage device 15; and to step down a DC voltage of vehicle electrical system 8 to a DC voltage of pulse-controlled inverter 5, thus also of energy storage device 15. Thus, since both a higher, as well as a lower voltage may be present, respectively generated in each case on both sides of DC/DC converter 6, bypass switching device 13 includes two semiconductor switches, and, in fact, in each case having oppositely polarized diodes in order to prevent an unintentional current flow across the diodes in the case of open power switches.

The exemplary embodiment schematically illustrated in FIG. 7 differs from that shown in FIG. 6 in DC/DC converter 6 by a further switch 64 for an additional voltage boost function, so that DC/DC converter of FIG. 7 encompasses two voltage reduction and voltage boost functions, in each case for a bidirectional operation. Thus, DC/DC converter 6 is additionally designed for stepping up a voltage of pulse-controlled inverter 5, thus also of energy storage device 15, to DC voltage of vehicle electrical system 8. Thus, energy storage device 15 may be discharged to below vehicle system voltage in order to then store more energy in energy storage device 15 during a recuperation phase, particularly in the case of a braking of the motor vehicle, where kinetic energy is converted by starter-generator 2 into electrical energy.

Moreover, energy storage device 15, namely a double-layer capacitor, is integrated in circuit configuration 4 within the structural unit of control device 1, thereby reducing the assembly outlay in the motor vehicle. The illustrations in all of the figures are merely schematic, and are not drawn true to scale. Apart from that, reference is made, in particular, to the graphical representations that are of importance to the present invention.

1-12. (canceled)

13. An electronic control device for controlling an electric machine connected to the electronic control device, comprising:
a control unit; and
a circuit configuration including a pulse-controlled inverter and a DC/DC converter;
wherein the control unit, the pulse-controlled inverter and the DC/DC converter are provided in one structural unit, and wherein the electric machine is a starter-generator for an internal combustion engine in a motor vehicle, and wherein the electronic control device is connected to an additional starter.

14. The electronic control device as recited in claim 13, wherein the circuit configuration includes the control unit, and wherein the control unit is operatively connected to the pulse-controlled inverter and the DC/DC converter.

15. The electronic control device as recited in claim 14, wherein the circuit configuration further includes a switching device for an electrical energy storage device.

16. The electronic control device as recited in claim 15, wherein the circuit configuration further includes the electrical energy storage device.

17. The electronic control device as recited in claim 14, wherein the circuit configuration further includes a bypass switching device for bypassing the DC/DC converter.

18. A method for operating an electronic control device connected to both (i) a starter-generator for an internal combustion engine of a vehicle and (ii) an additional starter, the electronic control device having a control unit and a circuit configuration including a pulse-controlled inverter, the method comprising:
driving the pulse-controlled inverter by the control unit; and
driving the DC/DC converter by the control unit.

19. The method as recited in claim 18, wherein the DC/DC converter converts a selected DC voltage of an electrical system of the vehicle to a different DC voltage.

20. The method as recited in claim 19, wherein the DC/DC converter steps down the selected DC voltage.

21. The method as recited in claim 19, wherein the DC/DC converter steps up the selected DC voltage.

22. The method as recited in claim 18, wherein the DC/DC converter converts a selected DC voltage to a DC voltage of an electrical system of the vehicle.

23. The method as recited in claim 19, wherein, in the case of recuperation of energy, the recuperated energy is stored in an energy storage device.

24. The method as recited in claim 18, wherein the pulse-controlled inverter limits an operating current for the starter-generator in an operation as starter motor for the internal combustion engine.
